(19) United States
(12) Patent Application Publication
(10) Pub. No.: US 2003/0182479 A1
(43) Pub. Date: Sep. 25, 2003

(54) Implementing clustering in raid controllers

(76) Inventors: Dieter Massa, Neckarsulm (DE); Otto Lehner, Neckarsulm (DE)

Correspondence Address: Timothy N. Trop, TROP, PRUNER & HU, P.C., STE 100, 8554 KATYFWY, HOUSTON, TX, 77024-1841, US

(21) Appl. No.: 10/104,894

(22) Filed: Mar. 22, 2002

(51) Int. Cl. G06F 3/00

(52) U.S. Cl. 710/36

(57) ABSTRACT

A cluster network may manage access to a RAID array by allowing only one controller of a group of controllers to access the same array at the same time. Tokens may be assigned for access to a given array by an appointed master controller. All other controllers requesting access to the array must request a token from the master. After the token has been assigned, the master may request the assigned token user to yield its access to the array in favor of another request. To detect network errors, each controller may monitor one or more neighboring controllers.

### BACKGROUND

This invention relates generally to controlling access to a clustered array of mass storage devices such as an array of disk drives.

A redundant array of inexpensive disks (RAID) (called a “RAID array”) is often selected as a mass storage for a computer system due to the array's ability to preserve data even if one of the disk drives of the array should fail. There are a number of RAID arrangements but most rely on redundancy to achieve a robust storage system. In some RAID systems, data is split, or stripped, across a plurality of disk drives such that if one disk drive fails, the data may still be recovered by using the information contained on the other disk drives in the system.

The RAID array may be part of a cluster environment, the environment in which two or more file servers share one or more RAID arrays. Typically, for purposes of assuring data consistency, only one of these file servers accesses a particular RAID array at a time to modify data. In this manner, when granted exclusive access to the RAID array, a particular file server may perform read and write operations as necessary to modify data contained in the RAID array. After the particular file server finishes its access, then another file server may be granted exclusive access to modify data in a particular RAID array.

For purposes of establishing a logical-to-physical interface between the file servers and the RAID array, one or more RAID controllers typically are used. As examples of the various possible arrangements, a single RAID controller may be contained in the enclosure that houses the RAID array, or alternatively, each file server may have an internal RAID controller. In the latter case, each file server may have an internal RAID controller card that is plugged into a card connector slot of the file server. Alternatively, the server may have the RAID functionality contained on a main printed circuit board.

For the case where the file server has an internal RAID controller, the file server (“Server”) is described herein as accessing the RAID array. However, it is understood that in these cases, it is actually the RAID controller card, or the RAID controller circuits on the main printed circuit board, of the server that is accessing the RAID array.

Before a particular server accesses a RAID array, the file server that currently is accessing the RAID array is responsible for closing all open read and write transactions. Hence, under normal circumstances, whenever a file server is granted access to a RAID array, all data on the shared disk drives of the array are in a consistent state.

In a clustering environment where different storage controllers access the same disk, the cluster operating system needs to guarantee data coherency. Thus, there is a need for better ways to control the distribution of access rights, and for recovering from network failures, in clustered RAID networks.

### BRIEF DESCRIPTION OF THE DRAWINGS

FIG. 1 is a block diagram of one embodiment of the present invention;

FIG. 2 is a depiction of software layers utilized in a controller in accordance with one embodiment of the present invention;

FIG. 3A is a flow chart for software utilized by a token requester in accordance with one embodiment of the present invention;

FIG. 3B is a continuation of the flow chart shown in FIG. 3A;

FIG. 3C is a flow chart of a functional block of FIG. 3A in accordance with one embodiment of the present invention;

FIG. 4 is a flow chart for software for implementing a token master in accordance with one embodiment of the present invention;

FIG. 5 is a depiction of a network in accordance with one embodiment of the present invention; and

FIG. 6 is a schematic depiction of one embodiment of the present invention.

### DETAILED DESCRIPTION

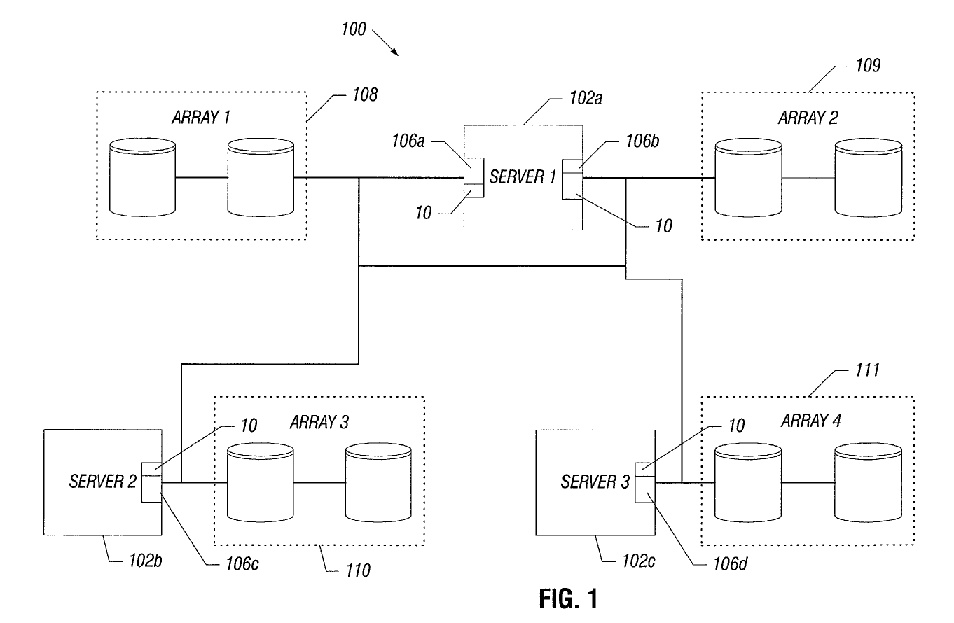

Referring to FIG. 1, a computer system 100, in accordance with one embodiment of the present invention, includes file servers 102 that are arranged in a cluster to share access to a clustered set of redundant array of inexpensive disks (RAID) array 108-111. Each server 102 performs an access to a RAID array 108-111 to the exclusion of the other servers 102. While an embodiment is illustrated with only three servers and four arrays, any number of servers and arrays may be utilized.

Each server 102 communicates with a RAID array 108-111 through a controller 106 that stores a software layer 10. In some embodiments, the controller 106 may be part of the server 102. In other embodiments, the controller 106 may be part of the RAID array 108-111. The controllers 106 may communicate with each other over a Storage Area Network (“SAN”), an Ethernet network or other communications network.

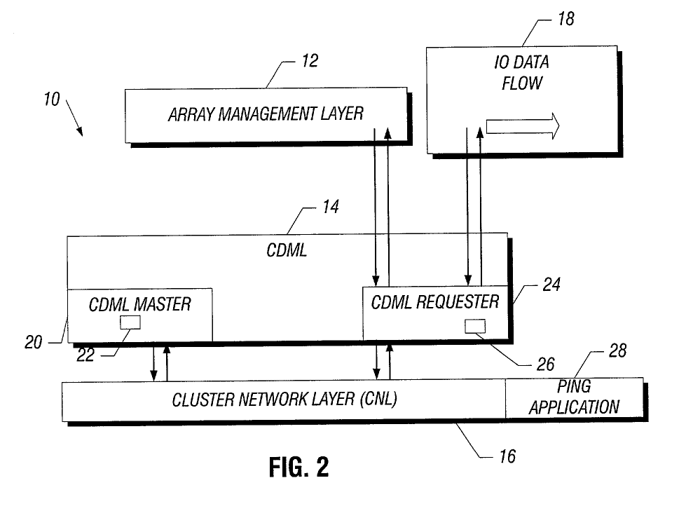

Referring to FIG. 2, the software layers 10 may include a cluster drive management layer (CDML) 14 that is coupled to a cluster network layer 16. The cluster network layer 16 may in turn be coupled to the various servers 102 and the RAID arrays 108-111. In addition, the cluster network layer 16 of one controller 106 may be coupled to the controllers 106 associated with other servers 102.

Coupled to the CDML 14 is an array management layer (“AML”) 12. The cluster network layer (“CNL”) 16 may be interfaced to all the other controllers 106 in the cluster 100. The CNL 16 may maintain login and logout of other controllers 106, intercontroller communication and may handle network failures. The CNL 16 may also provide the CDML 14 with communications services. The communications services may include handling redundant access to other controllers 106 if they are connected by more than one input/output channel.

The CNL may communicate with other controllers utilizing any communication medium and protocol. For example communications may utilize an Ethernet protocol that may be compatible with the protocol described in the Institute of Electrical and Electronics Engineers, Inc. (IEEE) Std 802.3, 2000 Edition, published on Oct. 20, 2000.and TCP/IP, a serial line and protocol, A Fibre Channel link that may comply or be compatible with the ANSI Standard Fibre Channel (FC) Physical and Signaling Interface-3 X3.303:1998 specification or a SCSI protocol that may comply or be compatible with the interface/protocol described in American National Standards Institute (ANSI) Small Computer Systems Interface-2 (SCSI2) ANSI X3.131-1994 Specification as four of many possible examples. However, it may be advantageous for the controllers to communicate by the medium and protocol being utilized for I/O data transfers.

For example if I/O data transfers utilize a SCSI-2 protocol, then data may be transferred using the “read buffer” or “write buffer” SCSI-2 commands. Also, the “ping” function, described below, may be accomplished by utilizing the SCSI-2 “inquiry” command.

A Ping Application (“PA”) 28 may also be coupled to the CNL 16. The Ping Application 28 may communicate with one or more neighboring controllers 102 to detect a network failure. For example, the PA may “ping” the neighboring controller. If the proper response to the “ping” is not received, the PA may determine that the neighboring controller has gone inactive due to a failure or other cause. Communications for the PA 28 may be performed by the CNL 16 in some embodiments.

In some embodiments, the neighboring controller may be determined by serial number where the “neighbor” has the next highest serial number. If there is not a controller with a higher serial number, then the “neighbor” may be the controller with the lowest serial number. The controllers then may form a ring or loop for the purposes of communications.

In the case of a login or a logout network event, the CNL 16 on a controller 106 logging in or out may call the CDML 14 to update its network information. In addition, the CNL may communicate changes to the PA 28. The CDML 14 is installed on every controller 106 in the cluster network 100. The CDML 14 knows all of the available controller 106 identifiers in the cluster network 100. These identifiers are reported through the cluster network layer 16. In addition, the CDML 14 is asynchronously informed of network changes by the cluster network layer 16. In one embodiment, the CDML 14 treats the list of known controllers 106 as a chain, where the local controller where the CDML is installed is always the last controller in the chain.

The generation of an access right called a token is based on a unique identifier in one embodiment of the present invention. This identifier may be the serial number of a requesting controller in one embodiment. For a particular RAID array 108-111, there are two types of access rights generated that belong to the same unique identifier, distinguished by the CDML 14. One type of access right may be reserved for array management (configuration access) and the other type of access right may be reserved for user data access. Within each access type there may be one or more tokens distinguished by sub-identifiers.

The CDML 14 of each controller 106 includes two control processes. One is called the token master 20 and the other is called the token requester 24. The master 20 may not be activated on each controller 106 but the capability of operating as a token master may be provided to every controller 106 in some embodiments. In some embodiments, ensuring that each controller 106 may be configured as a master ensures a symmetric flow of CDML 14 commands, whether the master is available on a local or a remote controller 106.

Both the CDML master 20 and the CDML requester 24 handle the tasks for all access tokens needed in the cluster network 100. The administration of the tokens is done in a way that treats every token separately in some embodiments.

A requester 24 from one controller 106 communicates with a master 20 from another controller 106 by exchanging commands. Each command is atomic. For example, a requester 24 may send a command to the master 20 to obtain an access token. The commands are encapsulated, in one embodiment, so that the master 20 only confirms receipt of the command. The master 20 sends a response to the requester 24 providing the token in some cases. Thus, the protocol utilized by the CDML 14 may be independent from that used for transmission of other rights and data.

A CDML command may consist of a small data buffer and may include a token identifier, a subtoken identifier, a request type, a master identifier, a generation index which is an incremented counter and a forward identifier which is the identifier where the token has to be forwarded upon master request. All of the communications are handled by the cluster network layer 16 in one embodiment of the present invention.

For each RAID array 108-111, there is a master 20 that controls the distribution of access tokens and which is responsible for general array management. Whenever a controller 106 wants to access a RAID array 104, it requests the corresponding token from the corresponding master of the array being accessed. In some embodiments, any controller may be allowed to read an array identification without an access token. This ability may be helpful for a controller 106 or associated server 102 to recognize what RAID arrays are online.

When access is granted, a controller 106 can access the particular array 108-111 as long as needed. However, in some embodiments, when a request to transfer the access token is received, it should be accommodated as soon as possible. In other embodiments, a token transfer may be accommodated upon the controller having the token completing a minimum number of IO transactions. Upon dedicated shut down, each controller 106 may ensure that all tokens have been returned and the logout is completed.

Each controller 106 guarantees that the data is coherent before the token is transferred to another controller. In one embodiment, all of the mechanisms described are based on controller 106 to controller 106 communications. Therefore, each controller 106 advantageously communicates with all of the other controllers in the network 100. Each controller 106 may have a unique identifier in one embodiment to facilitate connections and communications between controllers 106.

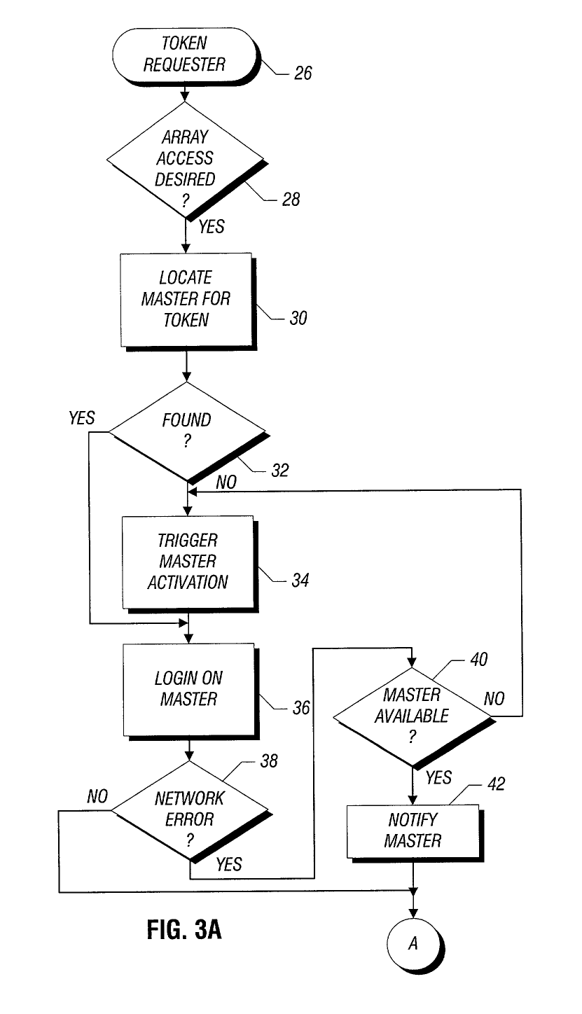

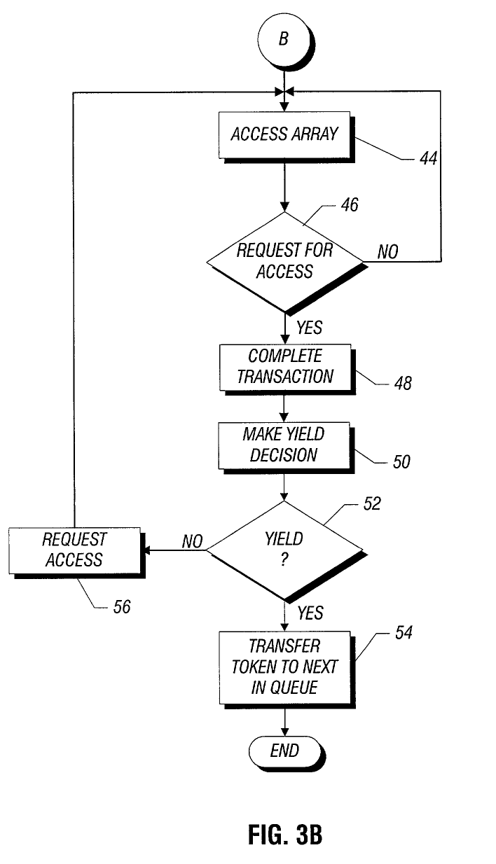

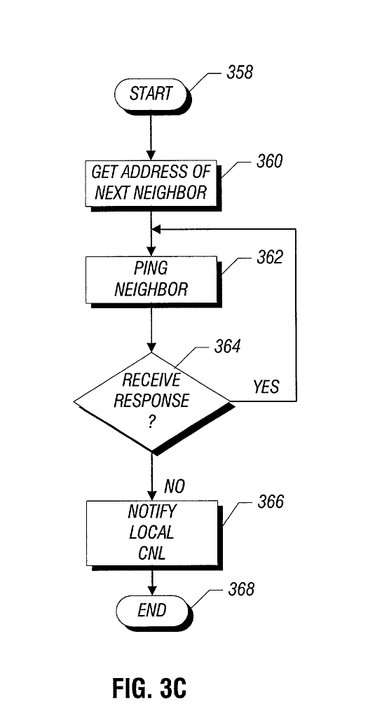

Referring to FIG. 3A, in one embodiment, the software 26 stored on a CDML requester 24 begins by determining whether the controller 106 on which the requester 24 is resident desires to access a RAID array 104, as indicated in diamond 28. If so, the requester 24 attempts to locate the master 20 for obtaining a token or access rights to the desired array, as indicated in block 30. If the master 20 is found, as determined in block 32, the requester logs in with the master as indicated in block 36. This generation activates the local master process for the master 20 that is in control of the particular array. Only one master 20 can be generated for a given token. If the master 20 is not found, the activation of a master can be triggered as indicated in block 34. Thereafter, the requester logs in with the appropriate master to receive a token as indicated in block 36.

A check at diamond 38 determines whether any network errors have occurred. One type of network failure may be the loss of a controller 106 that had logged in but not logged out. If so, a check at diamond 40 determines whether the master is still available. If so, the master is notified of the error because the master may be a remote controller 106. If there is no error, the flow continues.

Referring to FIG. 3B, the flow continues by accessing the requested array, as indicated in block 44. A check at diamond 46 determines whether another controller 106 has requested access to the same array. If not, the process continues to access the array.

When a second controller requests access to an array 104 being accessed by a first controller including the requester 24, the requester 24 that was previously granted the token makes a decision whether to yield to the second requester as indicated in block 50. If the requester decides to yield as determined in diamond 52, the requester 24 attempts to complete the transaction, or series of transactions, as soon as possible as indicated in block 48. When the transaction is completed, the requester 24 transfers the access token to the next requester in the queue as indicated in block 54. Otherwise the requester 24 again requests access to complete one or more additional transactions as indicated in block 54.

Referring to FIG. 3C, a PA 28 may begin 358 by getting the address of a next neighbor controller 360. Then, a “ping” function may be performed where the “ping” function is a communication with the neighbor controller to determine if the neighbor controller is still functional. At decision tree 364, if the neighbor controller is still functional, then the process continues by looping back and pinging the neighbor again 362. There may be a delay between “pings” in some embodiments to prevent excess communications from occurring.

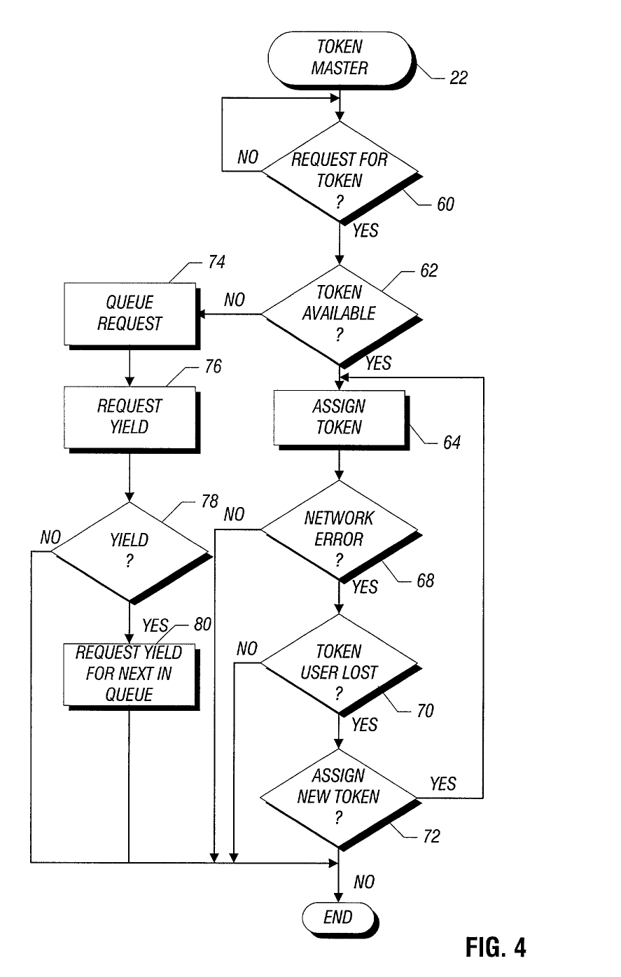

If at decision tree 364 the neighbor controller is determined to not be functional, for example it did not respond correctly to the “ping”, then the local CNL may be notified 366. This notification may be by direct communication from the PA to the master in some embodiments. In other embodiments the PA may set a flag that may be read to determine a network error such as at 38 in FIG. 3A and 68 in FIG. 4.

Referring to FIG. 4, the operation of the CDML master 20 software 22 begins with the receipt of a request for a token from a token requester 24, as indicated in diamond 60. When the master 20 receives a request for token, it checks to determine whether the token is available, as indicated in diamond 62. If so, the master may then request a yield to the next requester in the queue, as indicated in block 64.

A check at diamond 68 determines whether a network error has occurred. Again, one type of network error may be the loss of a controller 106. If so, a check at diamond 70 determines whether the token user has been lost. If so, a new token is assigned, as indicated in diamond 72.

If a token was not available, as determined at diamond 62, the request for the token may be queued, as indicated in block 74. The master 20 may then request that the current holder of the token yield to the new requester, as indicated in block 76. A check at diamond 78 determines whether the yield has occurred. If so, the token may then be granted to the requester 24 that has waited in the queue for the longest time, as indicated in block 80.

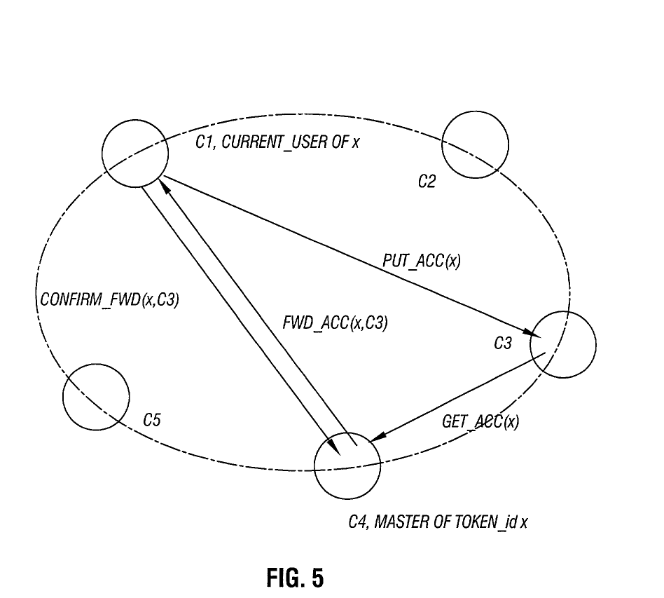

Referring to FIG. 5, a network may include a series of controllers C1 through C5. In this case, a controller C3 may make a request for an access token (GET_ACC(x)) from the controller C4 which is the master of a desired token. The current user of the token is the controller C1. In such case, the master C4 may forward the access request to the current user C1 and may receive a confirmation from C1. If the current user C1 is willing to yield, it can transfer the token to the controller C3. In such case, only three controllers 106 need to communicate in order to transfer the desired token.

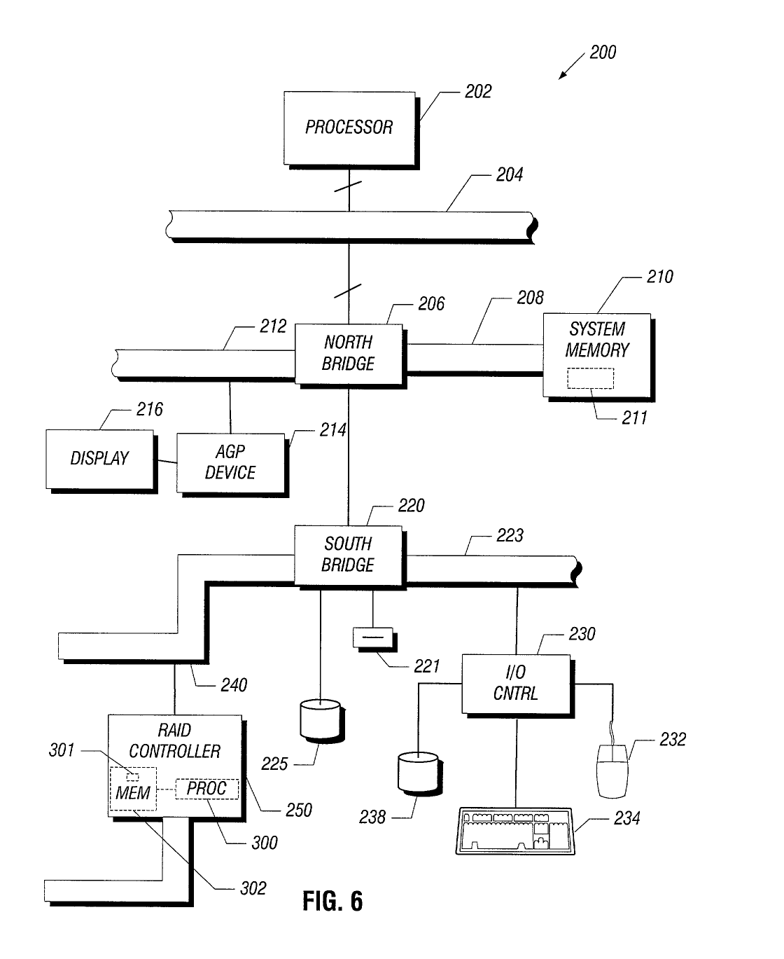

In some embodiments of the present invention, the server 102 may be a computer, such as exemplary computer 200 that is depicted in FIG. 6. The computer 200 may include a processor (one or more microprocessors, for example) 202, that is coupled to a local bus 204. Also coupled to local bus 204 may be, for example, a memory hub, or north bridge 206. The north bridge 206 provides interfaces to the local bus 204, a memory bus 208, an accelerated graphics port (AGP) bus 212 and a hub link. The AGP bus is described in detail in the Accelerated Graphics Port Interface Specification, Revision 1.0, published Jul. 31, 1996 by Intel Corporation, Santa Clara, Calif. A system memory 210 may be accessed via the system bus 208, and an AGP device 214 may communicate over the AGB bus 212 and generate signals to drive a display 216. The system memory 210 may store various program instructions such as the instructions described in connection with FIGS. 3A, 3B and 4. In this manner, in some embodiments of the present invention, those instructions enable the processor 202 to perform one or more of the techniques that are described above.

The north bridge 206 may communicate with a south bridge 210 over the hub link. In this manner, the south bridge 220 may provide an interface for the input/output (I/O) expansion bus 223 in a peripheral component interconnect (PCI) bus 240. The PCI specification is available from the PCI Special Interest Group, Portland, Oreg. 97214. An I/O controller 230 may be coupled to the I/O expansion bus 223 and may receive inputs from a mouse 232 and a keyboard 234 as well as control operations on a floppy disk drive 238. The south bridge 220 may, for example, control operations of a hard disk drive 225 and a compact disk read only memory (CD-ROM) drive 221.

A RAID controller 250 may be coupled to the bus 240 to establish communication between the RAID array 104 and the computer 200 via bus 252, for example. The RAID controller 250, in some embodiments of the present invention, may be in the form of a PCI circuit card that is inserted into a PCI slot of the computer 200, for example.

In some embodiments of the present invention, the RAID controller 250 includes a processor 300 and a memory 302 that stores instructions 310 such as those related to FIGS. 3A, 3B and 4. In this manner, in some embodiments of the present invention, those instructions enable the processor 300 to perform one or more of the techniques that are described above. Thus, in these embodiments, the processor 300 of the RAID controller 250 performs the RAID-related functions instead of the processor 202. In other embodiments of the present invention, both the processor 202 and the processor 300 may perform different RAID-related functions. Other variations are possible.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
assigning a token to a controller requesting access to a storage array coupled to a plurality of controllers;
in response to the token assignment, enabling the controller to access said array; and
at least one of the plurality of controllers determining, at least in part, if another controller is active or inactive.

2. The method of claim 1 including activating a master to assign access tokens.

3. The method of claim 2 including allocating only one token to access the storage array at a time.

4. The method of claim 3 including assigning a configuration token to the requesting controller.

5. The method of claim 3 including assigning a data token to the requesting controller.

6. The method of claim 2, in response to the detection an inactive controller, the at least one of the plurality of controllers notifying the master that a controller inactive.

7. The method of claim 6 including the master assigning a new token if a controller having an assigned token is inactive.

8. The method of claim 1 including receiving a request for access to the storage array and if the array is already being accessed, queue the request for access to the array.

9. The method of claim 8 including requesting that a controller having an assigned token yield its access to the storage array in response to a request from a second controller in the plurality of controllers to access the storage array.

10. The method of claim 9 including indicating to the controller having an assigned token to transfer the token to the second controller.

11. An article comprising a medium storing instructions that, if executed, enable a processor-based system to perform the steps of:
assigning a token to controller requesting access to a storage array coupled to a plurality of controllers;
in response to the token assignment, enabling the controller to access said storage array; and
at least one of the plurality of controllers determining, at least in part, if another controller is active or inactive.

12. The article of claim 11 wherein said medium stores instructions that, if executed, enable the processor-based system to activate a master to assign access tokens.

13. The article of claim 12 wherein said medium stores instructions that, if executed, enable the processor-based system to allocate only one token to access the storage array at a time.

14. The article of claim 13 wherein said medium stores instructions that, if executed, enable the processor-based system to assign a configuration token to the requesting controller.

15. The article of claim 13, wherein said medium stores instructions that, if executed, enable the processor-based system to assign a data token to the requesting controller.

16. The article of claim 12, wherein said medium stores instructions that, if executed, enable the processor-based system to notify the master that a controller is inactive.

17. The article of claim 16, wherein said medium stores instructions that, if executed, enable the processor-based system to assign a new token if a controller having an assigned token is inactive.

18. The article of claim 11, wherein said medium stores instructions that, if executed, enable the processor-based system to perform the steps of receiving a request for access to the storage array and if the storage array is already being accessed, queue the request for access to the storage array.

19. The article of claim 18, wherein said medium stores instructions that, if executed, enable the processor-based system to request that a controller having an assigned token yield its access to the storage array in response to a request from a second controller to access the storage array.

20. The article of claim 19, wherein said medium stores instructions that, if executed, enable the processor-based system to indicate to the controller having an assigned token to transfer the token to the second controller.

21. A processor-based system comprising:
a processor; and
a storage coupled to said processor storing instructions that, if executed, enable the processor to perform the steps of:
assigning a token to a controller requesting access to a storage array coupled to a plurality of controllers;
in response to the token assignment, enabling the controller to access said storage array; and
at least one of the plurality of controllers determining, at least in part, if another controller is active or inactive.

22. The system of claim 21, wherein said storage stores instructions that, if executed, enable the processor to activate a master to assign access tokens.

23. The system of claim 22, wherein said storage stores instructions that, if executed, enable the processor to allocate only one token to access the storage array at a time.

24. The system of claim 21, wherein said storage stores instructions that enable the processor to assign a configuration token to the requesting controller.

25. The system of claim 21, wherein said storage stores instructions that, if executed, enable the processor to assign a data token to the requesting controller.

26. The system of claim 23, wherein said storage stores instructions that, if executed, enable the processor to notify the master that a controller is inactive.

27. The system of claim 26, wherein said storage stores instructions that, if executed, enable the processor to assign a new token if a controller having an assigned token is inactive.

28. The system of claim 21, wherein said storage array is a cluster including a RAID array and at least two controllers coupled to the RAID array.

29. The system of claim 21, wherein said storage array is a cluster including at least two RAID storage arrays and at least two controllers coupled to the RAID arrays.

30. The system of claim 29, wherein one of said controllers is designated to be the master that grants a right to access the array.
